(19) United States
(12) Patent Application Publication
(10) Pub. No.: US 2022/0182508 A1
(43) Pub. Date: Jun. 9, 2022

(54) DISPLAY DEVICE AND METHOD OF IMAGE SCANNING

(71) Applicant: Au Optronics Corporation, Hsinchu (TW)

(72) Inventors: Hsun-Chen Chu, Hsinchu (TW); Tsu-Chien Tung, Hsinchu (TW); Yu-Han Huang, Hsinchu (TW); Chia-Bin Hsiao, Hsinchu (TW); Chao-Chien Chiu, Hsinchu (TW)

(73) Assignee: Au Optronics Corporation, Hsinchu (TW)

(21) Appl. No.: 17/516,711

(22) Filed: Nov. 2, 2021

(30) Foreign Application Priority Data
Dec. 9, 2020 (TW) 109143408

(51) Int. Cl. H04N 1/024; H04N 1/46; H04N 1/028

(52) U.S. Cl. CPC H04N 1/02445; H04N 1/0288; H04N 1/02805; H04N 1/465

(57) ABSTRACT

A display device includes a first substrate, a red sub-pixel, a green sub-pixel, a blue sub-pixel, a plurality of photosensitive devices, and a second substrate. The red sub-pixel, the green sub-pixel, and the blue sub-pixel are located on a first side of the first substrate. The photosensitive devices are located on the first side of the first substrate. Each of the photosensitive devices overlaps at least one of the red sub-pixel, the green sub-pixel, and the blue sub-pixel. Each of the photosensitive devices includes an active element and a photosensitive element. The active element is located on the first substrate. The photosensitive element is electrically connected to the active element. The second substrate overlaps the first substrate.

### CROSS-REFERENCE TO RELATED APPLICATION

This application claims the priority benefit of Taiwanese application no. 109143408, filed on Dec. 9, 2020. The entirety of the above-mentioned patent application is hereby incorporated by reference herein and made a part of this specification.

### BACKGROUND

### Technical Field

The disclosure relates to a display device and a method of image scanning.

### Description of Related Art

At present, identity verification is required in many places, such as airports, financial institutions, private companies, etc., and machines for identity verification can be found at entrances and exits in many of these places. For instance, the customs at the airport is equipped with devices for passport scanning to confirm the information of each passenger. A typical scanning device usually comes with a scanning platform and a display, the object to be scanned is placed on the scanning platform, and the operation is then performed according to the operation information displayed on the display.

### SUMMARY

The disclosure provides a display device in which the functions of image scanning and image displaying are combined.

The disclosure provides a method of image scanning capable of combining the function of image scanning into a display panel.

At least one embodiment of the disclosure provides a display device including a first substrate, a red sub-pixel, a green sub-pixel, a blue sub-pixel, a plurality of photosensitive devices, and a second substrate. The red sub-pixel, the green sub-pixel, and the blue sub-pixel are located on a first side of the first substrate. The photosensitive devices are located on the first side of the first substrate. Each of the photosensitive devices overlaps at least one of the red sub-pixel, the green sub-pixel, and the blue sub-pixel. Each of the photosensitive devices includes an active element and a photosensitive element. The active element is located on the first substrate. The photosensitive element is electrically connected to the active element. The second substrate overlaps the first substrate.

At least one embodiment of the disclosure further provides a display device including a first substrate, a pixel, a first photosensitive device, a second photosensitive device, and a second substrate. The pixel is located on the first substrate. The pixel includes a first sub-pixel, a second sub-pixel, and a third sub-pixel. The first photosensitive device overlaps the first sub-pixel and the second sub-pixel. The second photosensitive device overlaps the third sub-pixel. An area of the second photosensitive device is different from an area of the first photosensitive device. The second substrate overlaps the first substrate.

At least one embodiment of the disclosure further provides a display device including a first substrate, a pixel, a plurality of photosensitive devices, and a second substrate. The pixel is located on the first substrate. The pixel includes a first sub-pixel, a second sub-pixel, and a third sub-pixel. The photosensitive devices overlap the first sub-pixel, the second sub-pixel, and the third sub-pixel. The second substrate overlaps the first substrate. The disclosure further provides a method of image scanning, and the method includes the following steps. A display device is provided. An object is placed on the display device. A first sub-pixel is turned on. The display device emits first color light, and the first color light is received by at least one of photosensitive devices and converted into a first grayscale signal after reflecting off the object. A second sub-pixel is turned on. The display device emits second color light, and the second color light is received by at least one of the photosensitive devices and converted into a second grayscale signal after reflecting off the object. A third sub-pixel is turned on. The display device emits third color light, and the third color light is received by at least one of the photosensitive devices and converted into a third grayscale signal after reflecting off the object.

The first grayscale signal is multiplied by a first constant to obtain first color data. The second grayscale signal is multiplied by a second constant to obtain second color data. The third grayscale signal is multiplied by a third constant to obtain third color data. The first color data, the second color data, and the third color data are combined to obtain an image of the object.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic cross-sectional view of a display device according to an embodiment of the disclosure.

FIG. 2A is a schematic top view of a pixel and photosensitive devices according to an embodiment of the disclosure.

FIG. 2B is schematic top view of a black matrix and a first to a third color filter elements according to an embodiment of the disclosure.

FIG. 2C is a schematic cross-sectional view of a display panel according to an embodiment of the disclosure.

FIG. 3 is a schematic cross-sectional view of a display device according to an embodiment of the disclosure.

FIG. 4 is a schematic cross-sectional view of a display device according to an embodiment of the disclosure.

FIG. 5A is a schematic top view of a sensor panel according to an embodiment of the disclosure.

FIG. 5B is a schematic top view of a display panel according to an embodiment of the disclosure.

FIG. 5C is a schematic cross-sectional view of the display panel according to an embodiment of the disclosure.

FIG. 6 is a schematic top view of a pixel and photosensitive devices according to an embodiment of the disclosure.

FIG. 7 is a schematic graph of a relationship between external quantum efficiency (EQE, %) of the photosensitive device and a wavelength according to some embodiments of the disclosure.

FIG. 8 is a timing diagram of signals during scanning performed by a display device according to an embodiment of the disclosure.

### DESCRIPTION OF THE EMBODIMENTS

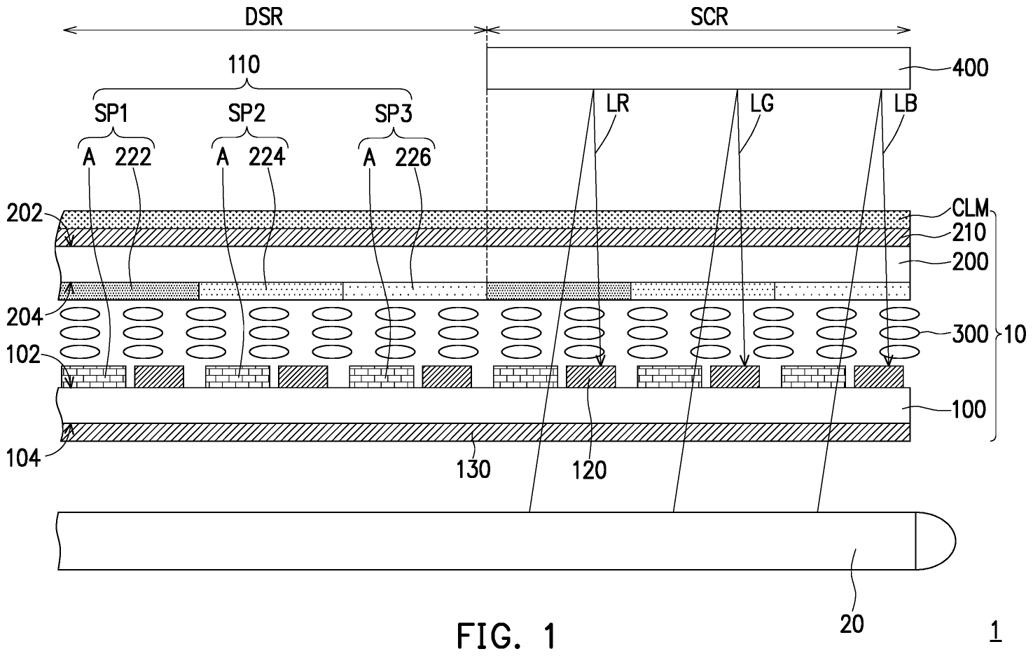

FIG. 1 is a schematic cross-sectional view of a display device according to an embodiment of the disclosure.

With reference to FIG. 1, a display device 1 includes a display panel 10 and a backlight module 20. The display panel 10 includes a first substrate 100, a plurality of pixels 110, a plurality of photosensitive devices 120, and a second substrate 200. In this embodiment, the display panel 10 further includes a liquid crystal layer 300, a collimator structure CLM, an upper polarizer 210, and a lower polarizer 130.

The first substrate 100 has a first side 102 and a second side 104 opposite to the first side 102, and the second side 104 of the first substrate 100 faces the backlight module 20.

The pixels 110 are located on the first side 102 of the first substrate 100. Each of the pixels 110 includes a first sub-pixel SP1, a second sub-pixel SP2, and a third sub-pixel SP3. In this embodiment, the first sub-pixel SP1, the second sub-pixel SP2, and the third sub-pixel SP3 respectively includes a first color filter element 222, a second color filter element 224, and a third color filter element 226. Further, each of the first sub-pixel SP1, the second sub-pixel SP2, and the third sub-pixel SP3 includes a switch element A and a pixel electrode (not shown in FIG. 1).

The photosensitive devices 120 are located on the first substrate 100. In this embodiment, the photosensitive devices 120, the first sub-pixels SP1, the second sub-pixels SP2, and the third sub-pixels SP3 are all located on the first side 102 of the first substrate 100. In this embodiment, each of the photosensitive devices 120 overlaps at least one of the red sub-pixels, the green sub-pixels, and the blue sub-pixels. For instance, each of the photosensitive devices 120 overlaps a first color filter element 222, a second color filter element 224, and a third color filter element 226. In this embodiment, a number of the photosensitive devices 120 is equal to a total number of the first sub-pixels SP1, the second sub-pixels SP2, and the third sub-pixels SP3, but the disclosure is not limited thereto. In other embodiments, the number of the photosensitive devices 120 is not equal to the total number of the first sub-pixels SP1, the second sub-pixels SP2, and the third sub-pixels SP3. The lower polarizer 130 is located on the second side 104 of the first substrate 100.

The second substrate 200 overlaps the first substrate 100. The second substrate 200 has a first side 202 and a second side 204 opposite to the first side 202, and the second side 204 of the second substrate 200 faces the first substrate 100. The first color filter element 222, the second color filter element 224, and the third color filter element 226 are located on the second side 204 of the second substrate 200. In some embodiments, the first color filter element 222, the second color filter element 224, and the third color filter element 226 respectively are a red filter element, a green filter element, and a blue filter element. Further, the first sub-pixel SP1, the second sub-pixel SP2, and the third sub-pixel SP3 respectively are a red sub-pixel, a green sub-pixel, and a blue sub-pixel. In this embodiment, each of the first color filter element 222, the second color filter element 224, and the third color filter element 226 overlaps one corresponding photosensitive device 120.

In this embodiment, the first color filter element 222, the second color filter element 224, and the third color filter element 226 are formed on the second side 204 of the second substrate 200, but the disclosure is not limited thereto. In other embodiments, the first color filter element 222, the second color filter element 224, and the third color filter element 226 are formed on the first side 102 of the first substrate 100 to form a color filter layer on a structure of a color filter on array (COA). In addition, in some embodiments, a black matrix BM is further provided among the first color filter element 222, the second color filter element 224, and the third color filter element 226.

The upper polarizer 210 is located on the first side 202 of the second substrate 200. The collimator structure CLM is located on the first side 202 of the second substrate 200 and overlaps the pixels 110 and the photosensitive devices 120. In some embodiments, a plurality of through hole (not shown) are provided on the collimator structure CLM. The collimator structure CLM allows light to travel in a direction perpendicular to a surface of the second substrate 200 after passing through the collimator structure CLM. The collimator structure CLM may be used to prevent peeping and may also be configured to limit an angle of reflected light entering the photosensitive devices, so that the reflected light coming from other neighboring pixels is prevented from entering the photosensitive devices 120 and is thereby prevented from causing crosstalk.

In this embodiment, an object 400 is placed on the display device 1 to allow the object 400 to be scanned. In this embodiment, a region of the display device 1 overlapping the object 400 is a scan region SCR, and a region of the display device 1 not overlapping the object 400 is a display region DSR. In the process of executing the scan function, the display region DSR may be used to display an operation message or other information. In the process of executing the scan function, the photosensitive devices 120 in the display region DSR do not perform signal processing, and the photosensitive devices 120 in the scan region SCR perform signal processing. A size of the scan region SCR may be adjusted according to a size of the object 400.

A method of scanning of the object 400 includes the following steps. The first sub-pixel SP1 is turned on. A light ray is emitted from the backlight module 20 and passes through the first sub-pixel SP1, so that the display device 1 emits first color light LR (e.g., red light). After reflecting off the object 400, the first color light LR is received by at least one of the photosensitive devices 120 and converted into a first grayscale signal GS1. The second sub-pixel SP2 is turned on. A light ray is emitted from the backlight module 20 and passes through the second sub-pixel SP1, so that the display device 1 emits second color light LG (e.g., green light). After reflecting off the object 400, the second color light LG is received by at least one of the photosensitive devices 120 and converted into a second grayscale signal GS2. The third sub-pixel SP3 is turned on. A light ray is emitted from the backlight module 20 and passes through the third sub-pixel SP3, so that the display device 1 emits third color light LB (e.g., blue light). After reflecting off the object 400, the third color light LB is received by at least one of the photosensitive devices 120 and converted into a third grayscale signal GS3.

In some embodiment, the first sub-pixel SP1, the second sub-pixel SP2, and the third sub-pixel SP3 are turned on at the same time, but the disclosure is not limited thereto. In other embodiments, the first sub-pixel SP1, the second sub-pixel SP2, and the third sub-pixel SP3 are turned on at different times. In other embodiments, the first sub-pixel SP1 and the third sub-pixel SP3 are turned on at the same time, and the second sub-pixel SP2 is not turned on when the first sub-pixel SP1 and the third sub-pixel SP3 are turned on.

The first grayscale signal GS1 is multiplied by a first constant η₁ to obtain first color data (e.g., to obtain the shade of red). The second grayscale signal GS2 is multiplied by a second constant η₂ to obtain second color data (e.g., to obtain the shade of green). The third grayscale signal GS2 is multiplied by a third constant η₂ to obtain third color data (e.g., to obtain the shade of blue). Next, the first color data, the second color data, and the third color data are combined to obtain an image of the object, and in some embodiments, the image is a color image. The first constant η₁, the second constant η₂, and the third constant η₃ may change according to energy corresponding to a light-receiving wavelength band of a material selected for the photosensitive devices 120 and the external quantum efficiency of the photosensitive devices 120. The aforementioned corresponding energy refers to the electromagnetic wave energy corresponding to the wavelength of the light entering the sub-pixels through the filter elements and reaching the photosensitive devices.

In this embodiment, the first sub-pixel SP1, the second sub-pixel SP2, and the third sub-pixel SP3 are not self-luminous elements, but the disclosure is not limited thereto. In other embodiments, the first sub-pixel SP1, the second sub-pixel SP2, and the third sub-pixel SP3 are self-luminous elements (e.g., micro light-emitting diodes or organic light-emitting diodes), and the backlight module is not required to be arranged in the display device.

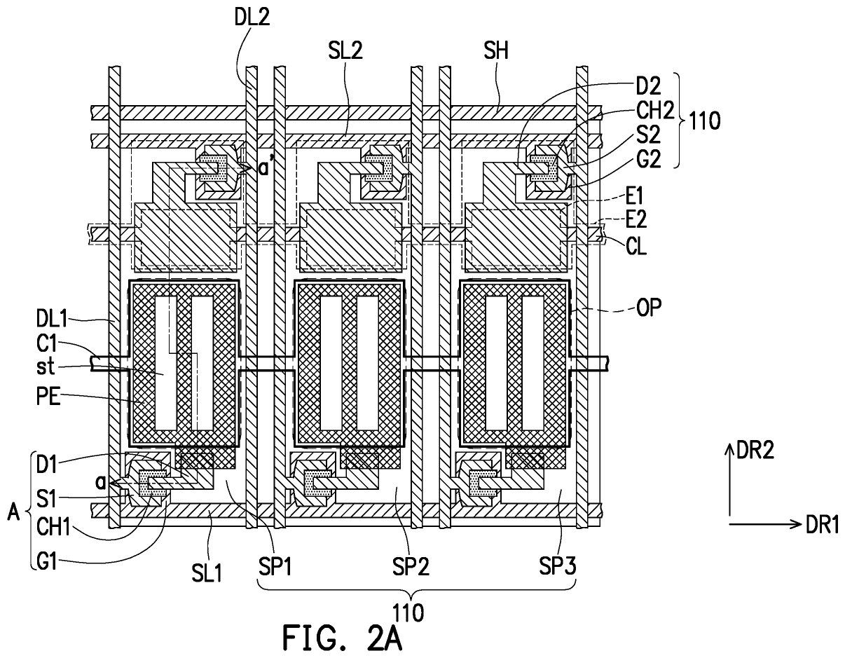

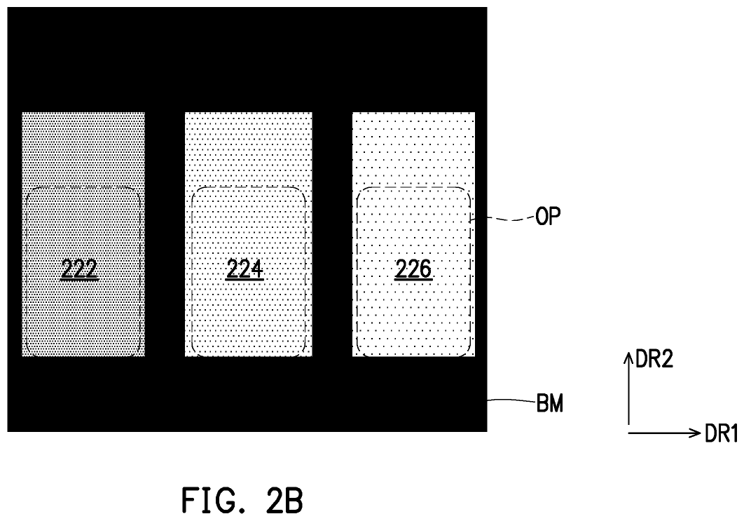

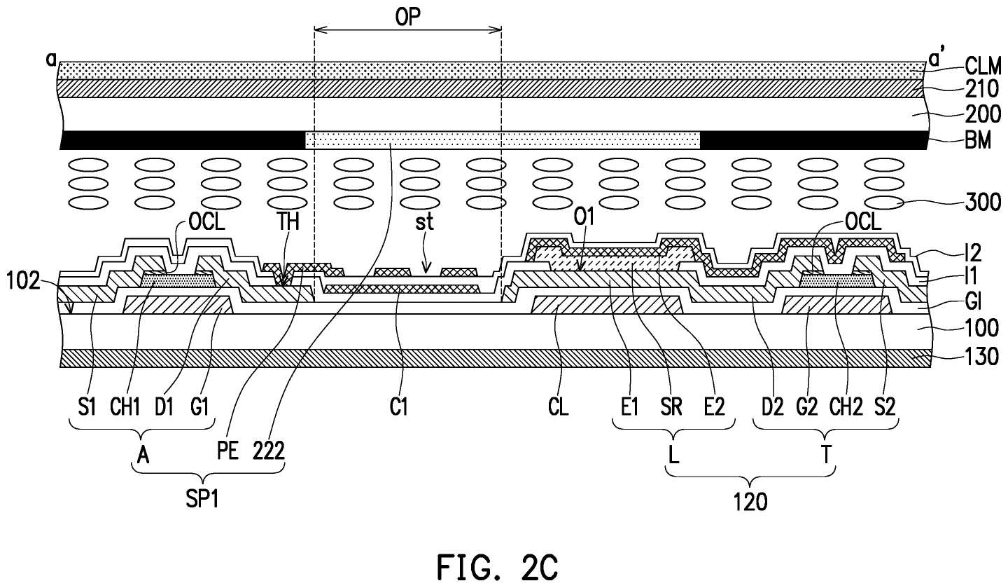

FIG. 2A is a schematic top view of a pixel and photosensitive devices according to an embodiment of the disclosure. For the convenience of description, part of the structure is omitted in FIG. 2A. FIG. 2B is schematic top view of a black matrix and a first to a third color filter elements according to an embodiment of the disclosure. FIG. 2C is a schematic cross-sectional view of a display panel according to an embodiment of the disclosure. FIG. 2C is a schematic cross-sectional view taken along a line a-a′ depicted in FIG. 2A, for example. The first sub-pixel SP1, the second sub-pixel SP2, and the third sub-pixel SP3 in FIG. 2A have similar structures, and the first sub-pixel SP1 is treated as an example for description in FIG. 2C.

With reference to FIG. 2A to FIG. 2C, each of the first sub-pixel SP1, the second sub-pixel SP2, and the third sub-pixel SP3 includes the switch element A and a pixel electrode PE electrically connected to the switch element A. The switch element A is located on the first side 102 of the first substrate 100.

In this embodiment, the switch element A includes a gate G1, a channel CH1, a source S1, and a drain D1. The gate G1 is electrically connected to a scan line SL1. The channel CH1 is located above the gate G1, and a gate insulating layer GI is sandwiched between the channel CH1 and the gate G1. The source S1 and the drain D1 are located above the channel CH1, and the source S1 is electrically connected to a data line DL1. In some embodiments, ohmic contact layers OCL are provided between the source S1 and the channel CH1 and between the drain D1 and the channel CH1, but the disclosure is not limited thereto. A bottom-gate type thin film transistor is treated as an example to act as the switch element A for description, but the disclosure is not limited thereto. According to other embodiments, the switch element A may also be a top-gate type thin film transistor.

A first insulating layer I1 covers the switch element A. A common electrode C1 (not shown in FIG. 2A) is located on the first insulating layer I1. The common electrodes C1 of the first sub-pixel SP1, the second sub-pixel SP2, and the third sub-pixel SP3 are connected to one another. A second insulating layer I2 covers the common electrode C1. The pixel electrode PE is located on the second insulating layer I2 and is electrically connected to the drain D1 via a through hole TH, and the through hole TH penetrates the first insulating layer I1 and the second insulating layer I2. The pixel electrode PE has a plurality of slits st overlapping an opening region OP, and the pixel electrode PE overlaps the common electrode C1. A material of the pixel electrode PE includes, for example, indium tin oxide, indium zinc oxide, aluminum tin oxide, aluminum zinc oxide, indium germanium zinc oxide, other suitable oxides, or a stacked layer including at least two of the foregoing.

The photosensitive devices 120 are located on the first side 102 of the first substrate 100. Each of the photosensitive devices 120 includes an active element T and a photosensitive element L. The active element T is located on the first side 102 of the first substrate 100.

In this embodiment, the active element T includes a gate G2, a channel CH2, a source S2, and a drain D2. The gate G2 is electrically connected to a scan line SL2. The channel CH2 is located above the gate G2, and the gate insulating layer GI is sandwiched between the channel CH2 and the gate G2. The source S2 and the drain D2 are located above the channel CH2, and the source S2 is electrically connected to a data line DL2. In some embodiments, the ohmic contact layers OCL are provided between the source S2 and the channel CH2 and between the drain D2 and the channel CH2, but the disclosure is not limited thereto. A bottom-gate type thin film transistor is treated as an example to act as the active element T for description, but the disclosure is not limited thereto. According to other embodiments, the active element T may also be a top-gate type thin film transistor.

A common signal line CL is located on the first side 102 of the first substrate 100. In this embodiment, the common signal line CL, the gate G1, the scan line SL1, the gate G2, and the scan line SL2 belong to a same conductive layer, and materials thereof include, for example, metals, alloys, nitrides of metallic materials, oxides of metallic materials, oxynitrides of metallic materials, or other suitable materials, or stacked layers of metallic materials and other conductive materials. The common signal line CL, the scan line SL1, and the scan line SL2 substantially extend in a first direction DR1. The gate insulating layer GI covers the common signal line CL.

The photosensitive element L is located above the gate insulating layer GI and overlaps the common signal line CL. The photosensitive element L includes a first electrode E1, a second electrode E2, and a photosensitive layer SR. The first electrode E1 is electrically connected to the active element T and the drain D2. In this embodiment, the first electrode E1, the source S1, the drain D1, the data line DL1, the source S2, the drain D2, and the data line DL2 belong to the same conductive layer, and materials thereof include, for example, metals, alloys, nitrides of metallic materials, oxides of metallic materials, oxynitrides of metallic materials, or other suitable materials, or stacked layers of metallic materials and other conductive materials. The data line DL1 and the data line DL2 substantially extend in a second direction DR2.

The first insulating layer I1 covers the active element T and has an opening O1 overlapping the first electrode E1. The photosensitive layer SR is located in the opening O1 and contacts the first electrode E1. A material of the photosensitive layer SR includes, for example, a silicon-rich oxide layer, but the disclosure is not limited thereto. In other embodiments, the photosensitive layer SR includes a stacked layer of a P-type semiconductor, an intrinsic semiconductor, and an N-type semiconductor. The second electrode E2 is located on the photosensitive layer SR and contacts the photosensitive layer SR. In this embodiment, plural second electrodes E2 are connected to one another and extend in the first direction DR1. In this embodiment, the second electrode E2 and the common electrode C1 belong to the same conductive layer, and materials thereof include, for example, indium tin oxide, indium zinc oxide, aluminum tin oxide, aluminum zinc oxide, indium germanium zinc oxide, other suitable oxides, or a stacked layer including at least two of the foregoing. In this embodiment, the second electrode E2 covers the active element T, but the disclosure is not limited thereto. In other embodiments, the second electrode E2 does not cover the active element T.

The liquid crystal layer 300, the switch element A, the active element T, and the photosensitive element L are located between the first substrate 100 and the second substrate 200. The first color filter element 222, the second color filter element 224, and the third color filter element 226 are located on the second substrate 200 and respectively are a red filter element, a green filter element, and a blue filter element. In this embodiment, three photosensitive elements L individually overlap the red filter element, the green filter element, and the blue filter element. In other embodiments, the first color filter element 222, the second color filter element 224, and the third color filter element 226 are formed on the first side 102 of the first substrate 100 to form the color filter layer on the structure of the color filter on array (COA). In some embodiments, the black matrix BM is further provided among the first color filter element 222, the second color filter element 224, and the third color filter element 226. In some embodiments, the black matrix BM overlaps the scan line SL1, the scan line SL2, the data line DL1, the data line DL2, the switch element A, and the active element T in the direction perpendicular to the second substrate 200. A light ray may pass through the openings of the black matrix BM to reach the photosensitive layer SR and the opening region OP.

In this embodiment, each of the first sub-pixel SP1, the second sub-pixel SP2, and the third sub-pixel SP3 includes the switch element A and the pixel electrode PE electrically connected to the switch element A, and the first sub-pixel SP1, the second sub-pixel SP2, and the third sub-pixel SP3 respectively includes the first color filter element 222, the second color filter element 224, and the third color filter element 226. The first color filter element 222, the second color filter element 224, and the third color filter element 226 overlap the switch element A and the pixel electrode PE.

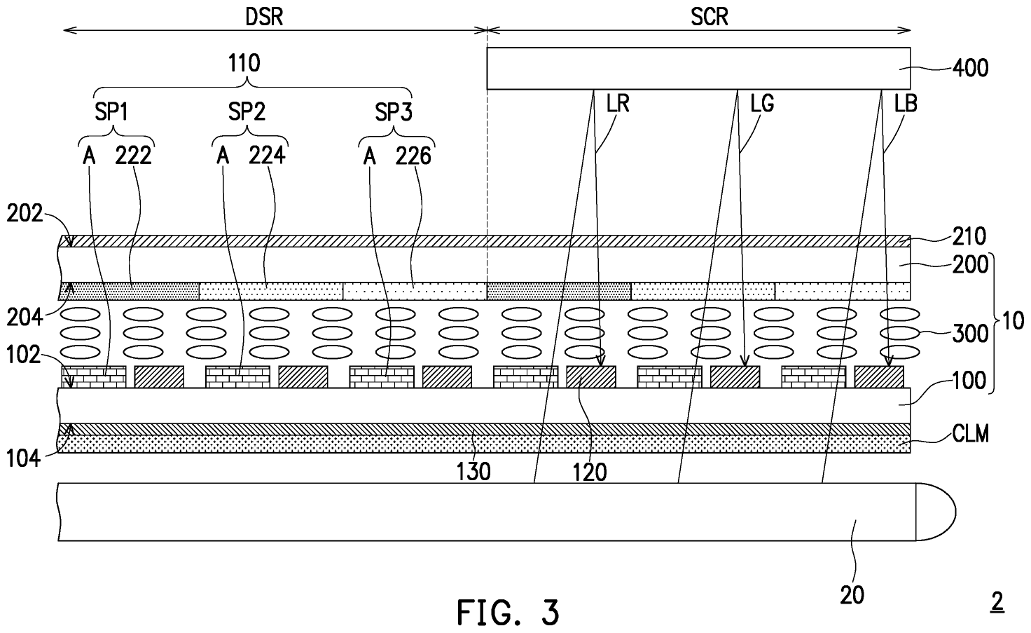

FIG. 3 is a schematic cross-sectional view of a display device according to an embodiment of the disclosure. It should be noted that the reference numerals and a part of the contents in the embodiment of FIG. 1 are also used to describe the embodiment of FIG. 3, in which the same reference numerals are used to represent identical or similar elements, and thus descriptions of the same technical contents are omitted. Please refer to the descriptions of the previous embodiments for the omitted part, which will not be repeated hereinafter.

The difference between a display device 2 of FIG. 3 and the display device 1 of FIG. 1 is that the collimator structure CLM of the display device 2 is disposed between the first substrate 100 and the backlight module 20. In this embodiment, the collimator structure CLM is disposed on the lower polarizer 130.

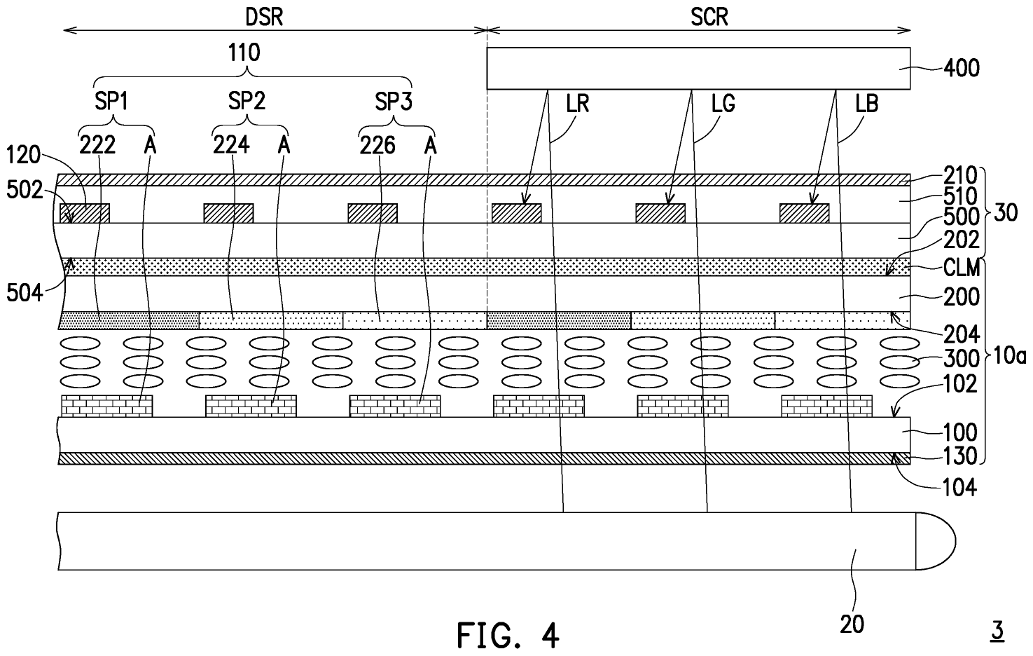

FIG. 4 is a schematic cross-sectional view of a display device according to an embodiment of the disclosure. It should be noted that the reference numerals and a part of the contents in the embodiment of FIG. 1 are also used to describe the embodiment of FIG. 4, in which the same reference numerals are used to represent identical or similar elements, and thus descriptions of the same technical contents are omitted. Please refer to the descriptions of the previous embodiments for the omitted part, which will not be repeated hereinafter.

The difference between a display device 3 of FIG. 4 and the display device 1 of FIG. 1 mainly is that the photosensitive devices 120 of the display device 3 are not disposed between the first substrate 100 and the second substrate 200.

With reference to FIG. 4, the display device 3 includes a display panel 10a, the backlight module 20, and a sensor panel 30 ° The display panel 10a includes the first substrate 100, the pixels 110, and the second substrate 200. In this embodiment, the display panel 10a further includes the liquid crystal layer 300, the collimator structure CLM, the lower polarizer 130, the first color filter element 222, the second color filter element 224, and the third color filter element 226. The sensor panel 30 includes a third substrate 500, the photosensitive devices 120, a protecting layer 510, and the upper polarizer 210.

The first substrate 100 has the first side 102 and the second side 104 opposite to the first side 102, and the second side 104 of the first substrate 100 faces the backlight module 20.

The pixels 110 are located on the first side 102 of the first substrate 100. Each of the pixels 110 includes the first sub-pixel SP1, the second sub-pixel SP2, and the third sub-pixel SP3. In this embodiment, the first sub-pixel SP1, the second sub-pixel SP2, and the third sub-pixel SP3 respectively includes the first color filter element 222, the second color filter element 224, and the third color filter element 226. Further, each of the first sub-pixel SP1, the second sub-pixel SP2, and the third sub-pixel SP3 includes the switch element A and the pixel electrode (not shown in FIG. 1). The lower polarizer 130 is located on the second side 104 of the first substrate 100.

The second substrate 200 overlaps the first substrate 100. The second substrate 200 has the first side 202 and the second side 204 opposite to the first side 202, and the second side 204 of the second substrate 200 faces the first substrate 100. The first color filter element 222, the second color filter element 224, and the third color filter element 226 are located on the second side 204 of the second substrate 200. The first color filter element 222, the second color filter element 224, and the third color filter element 226 respectively are a red filter element, a green filter element, and a blue filter element. Further, the first sub-pixel SP1, the second sub-pixel SP2, and the third sub-pixel SP3 respectively are a red sub-pixel, a green sub-pixel, and a blue sub-pixel.

In this embodiment, the first color filter element 222, the second color filter element 224, and the third color filter element 226 are formed on the second side 204 of the second substrate 200, but the disclosure is not limited thereto. In other embodiments, the first color filter element 222, the second color filter element 224, and the third color filter element 226 are formed on the first side 102 of the first substrate 100 to form the color filter layer on the structure of the color filter on array (COA). In addition, in some embodiments, the black matrix BM is further provided among the first color filter element 222, the second color filter element 224, and the third color filter element 226.

The collimator structure CLM is located on the first side 202 of the second substrate 200. In some embodiments, a plurality of through hole (not shown) are provided on the collimator structure CLM. The collimator structure CLM allows light to travel in the direction perpendicular to the surface of the second substrate 200 after passing through the collimator structure CLM. The collimator structure CLM may be used to prevent peeping and may also be configured to limit the angle of reflected light entering the photosensitive devices, so that the reflected light coming from other neighboring pixels is prevented from entering the photosensitive devices 120 and is thereby prevented from causing crosstalk.

The third substrate 500 overlaps the second substrate 200. The third substrate 500 has a first side 502 and a second side 504 opposite to the first side 502, and the second side 504 of the third substrate 500 faces the first side 202 of the second substrate 200. The photosensitive devices 120 are located on the first side 502 of the third substrate 500. In this embodiment, each of the first sub-pixel SP1, the second sub-pixel SP2, and the third sub-pixel SP3 overlaps one corresponding photosensitive device 120, but the disclosure is not limited thereto. In some embodiments, one photosensitive device 120 overlaps at least two of the first sub-pixel SP1, the second sub-pixel SP2, and the third sub-pixel SP3.

The protecting layer 510 covers the photosensitive devices 120. The upper polarizer 210 is located on the protecting layer 510.

In this embodiment, the object 400 is placed on the display device 3 to allow the object 400 to be scanned. In this embodiment, the region overlapping the object 400 is the scan region SCR, and the region not overlapping the object 400 is the display region DSR. In the process of executing the scan function, the display region DSR may be used to display an operation message or other information. In the process of executing the scan function, the photosensitive devices 120 in the display region DSR do not perform signal processing, and the photosensitive devices 120 in the scan region SCR perform signal processing. The size of the scan region SCR may be adjusted according to the size of the object 400.

A method of scanning of the object 400 includes the following steps. The first sub-pixel SP1 is turned on. A light ray is emitted from the backlight module 20 and passes through the first sub-pixel SP1, so that the display device 3 emits the first color light LR (e.g., red light). After reflecting off the object 400, the first color light LR is received by at least one of the photosensitive devices 120 and converted into the first grayscale signal GS1. The second sub-pixel SP2 is turned on. A light ray is emitted from the backlight module 20 and passes through the second sub-pixel SP1, so that the display device 3 emits the second color light LG (e.g., green light). After reflecting off the object 400, the second color light LG is received by at least one of the photosensitive devices 120 and converted into the second grayscale signal GS2. The third sub-pixel SP3 is turned on. A light ray is emitted from the backlight module 20 and passes through the third sub-pixel SP3, so that the display device 3 emits the third color light LB (e.g., blue light). After reflecting off the object 400, the third color light LB is received by at least one of the photosensitive devices 120 and converted into the third grayscale signal GS3.

In some embodiment, the first sub-pixel SP1, the second sub-pixel SP2, and the third sub-pixel SP3 are turned on at the same time, but the disclosure is not limited thereto. In other embodiments, the first sub-pixel SP1, the second sub-pixel SP2, and the third sub-pixel SP3 are turned on at different times. In other embodiments, the first sub-pixel SP1 and the third sub-pixel SP3 are turned on at the same time, and the second sub-pixel SP2 is not turned on when the first sub-pixel SP1 and the third sub-pixel SP3 are turned on.

The first grayscale signal GS1 is multiplied by the first constant η₁ to obtain the first color data (e.g., to obtain the shade of red). The second grayscale signal GS2 is multiplied by the second constant η₂ to obtain the second color data (e.g., to obtain the shade of green). The third grayscale signal GS2 is multiplied by the third constant η₂ to obtain the third color data (e.g., to obtain the shade of blue). The first color data, the second color data, and the third color data are then combined to obtain an image of the object. In some embodiments, the image may be a color image. The first constant η₁, the second constant η₂, and the third constant η₃ may change according to the energy of the light-receiving wavelength band corresponding to the material selected for the photosensitive devices 120 and the external quantum efficiency of the photosensitive devices 120.

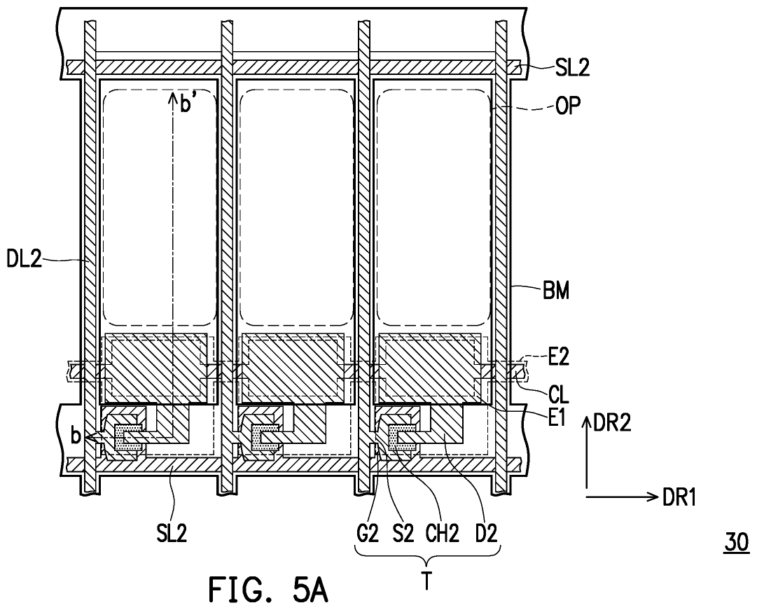

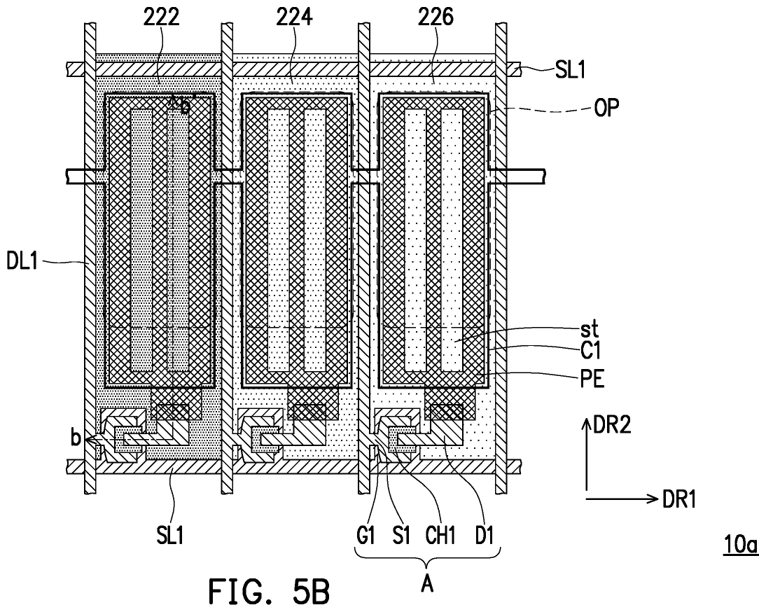

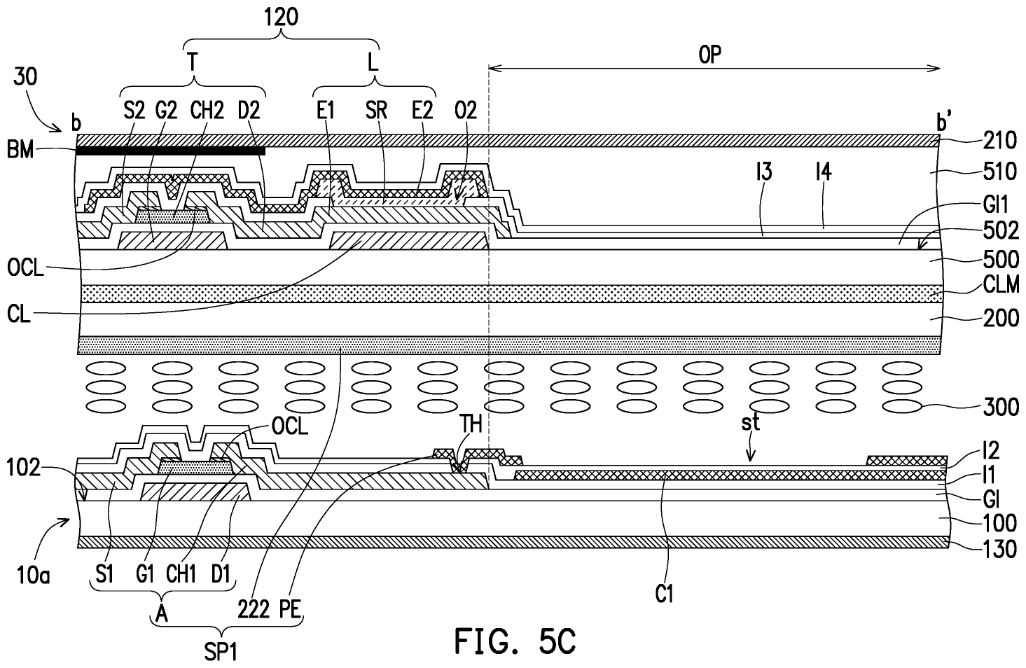

FIG. 5A is a schematic top view of a sensor panel according to an embodiment of the disclosure. For the convenience of description, part of the structure is omitted in FIG. 5A. FIG. 5B is a schematic top view of a display panel according to an embodiment of the disclosure. FIG. 5C is a schematic cross-sectional view of the display panel according to an embodiment of the disclosure. FIG. 5C is a schematic cross-sectional view taken along a line b-b′ depicted in FIG. 5A and FIG. 5B, for example. The first sub-pixel SP1, the second sub-pixel SP2, and the third sub-pixel SP3 in FIG. 5A have similar structures, and the first sub-pixel SP1 is treated as an example for description in FIG. 5C.

With reference to FIG. 5A to FIG. 5C, each of the first sub-pixel SP1, the second sub-pixel SP2, and the third sub-pixel SP3 of the display panel 10a includes the switch element A and the pixel electrode PE electrically connected to the switch element A. The switch element A is located on the first side 102 of the first substrate 100.

In this embodiment, the switch element A includes the gate G1, the channel CH1, the source S1, and the drain D1. The gate G1 is electrically connected to the scan line SL1. The channel CH1 is located above the gate G1, and the gate insulating layer GI is sandwiched between the channel CH1 and the gate G1. The source S1 and the drain D1 are located above the channel CH1, and the source S1 is electrically connected to the data line DLL In some embodiments, the ohmic contact layers OCL are provided between the source S1 and the channel CH1 and between the drain D1 and the channel CH1, but the disclosure is not limited thereto. A bottom-gate type thin film transistor is treated as an example to act as the switch element A for description, but the disclosure is not limited thereto. According to other embodiments, the switch element A may also be a top-gate type thin film transistor.

The first insulating layer I1 covers the switch element A. The common electrode C1 is located on the first insulating layer I1. The second insulating layer I2 covers the common electrode C1. The pixel electrode PE is located on the second insulating layer I2 and is electrically connected to the drain D1 via the through hole TH, and the through hole TH penetrates the first insulating layer I1 and the second insulating layer I2. The pixel electrode PE has a plurality of slits st overlapping the opening region OP, and the pixel electrode PE overlaps the common electrode C1. The materials of the pixel electrode PE and the common electrode C1 include, for example, indium tin oxide, indium zinc oxide, aluminum tin oxide, aluminum zinc oxide, indium germanium zinc oxide, other suitable oxides, or a stacked layer including at least two of the foregoing.

The liquid crystal layer 300, the switch element A, the active element T, and the photosensitive element L are located between the first substrate 100 and the second substrate 200. The first color filter element 222, the second color filter element 224, and the third color filter element 226 are located on the second substrate 200 and respectively are a red filter element, a green filter element, and a blue filter element.

The third substrate 500 is located on the second substrate 200. The collimator structure CLM is located between the third substrate 500 and the second substrate 200.

The photosensitive devices 120 are located on the first side 502 of the third substrate 500. Each of the photosensitive devices 120 includes the active element T and the photosensitive element L. The active element T is located on the first side 502 of the third substrate 500.

In this embodiment, the active element T includes the gate G2, the channel CH2, the source S2, and the drain D2. The gate G2 is electrically connected to the scan line SL2. The channel CH2 is located above the gate G2, and a gate insulating layer GI is sandwiched between the channel CH2 and the gate G2. The source S2 and the drain D2 are located above the channel CH2, and the source S2 is electrically connected to the data line DL2. In some embodiments, the ohmic contact layers OCL are provided between the source S2 and the channel CH2 and between the drain D2 and the channel CH2, but the disclosure is not limited thereto. A bottom-gate type thin film transistor is treated as an example to act as the active element T for description, but the disclosure is not limited thereto. According to other embodiments, the active element T may also be a top-gate type thin film transistor.

In some embodiments, the switch element A and the active element T overlap in the direction perpendicular to the first substrate 100, the scan line SL1 and the scan line SL2 overlap in the direction perpendicular to the first substrate 100, and the data line DL1 and the data line DL2 overlap in the direction perpendicular to the first substrate 100, so an aperture ratio of each sub-pixel is increased in this way.

The common signal line CL is located on the first side 502 of the third substrate 500. The gate insulating layer GI1 covers the common signal line CL. In this embodiment, the common signal line CL, the gate G2, and the scan line SL2 belong to the same conductive layer, and the materials thereof include, for example, metals, alloys, nitrides of metallic materials, oxides of metallic materials, oxynitrides of metallic materials, or other suitable materials, or stacked layers of metallic materials and other conductive materials. The common signal line CL and the scan line SL2 substantially extend in the first direction DR1.

The photosensitive element L is located above the gate insulating layer GI1 and overlaps the common signal line CL. The photosensitive element L includes the first electrode E1, the second electrode E2, and the photosensitive layer SR. The first electrode E1 is electrically connected to the active element T and the drain D2. In this embodiment, the first electrode E1, the source S2, the drain D2, and the data line DL2 belong to the same conductive layer, and the materials thereof include, for example, metals, alloys, nitrides of metallic materials, oxides of metallic materials, oxynitrides of metallic materials, or other suitable materials, or stacked layers of metallic materials and other conductive materials. The data line DL2 substantially extends in the second direction DR2.

A third insulating layer I3 covers the active element T and has an opening O2 overlapping the first electrode E1. The photosensitive layer SR is located in the opening O2 and contacts the first electrode E1. The material of the photosensitive layer SR includes, for example, a silicon-rich oxide layer, but the disclosure is not limited thereto. In other embodiments, the photosensitive layer SR includes a stacked layer of a P-type semiconductor, an intrinsic semiconductor, and an N-type semiconductor. The second electrode E2 is located on the photosensitive layer SR and contacts the photosensitive layer SR. In this embodiment, plural second electrodes E2 are connected to one another and extend in the first direction DR1. In this embodiment, the material of the second electrode E2 includes, for example, indium tin oxide, indium zinc oxide, aluminum tin oxide, aluminum zinc oxide, indium germanium zinc oxide, other suitable oxides, or a stacked layer including at least two of the foregoing. In this embodiment, the second electrode E2 covers the active element T, but the disclosure is not limited thereto. In other embodiments, the second electrode E2 does not cover the active element T.

A fourth insulating layer I4 is located on the second electrode E2 and the third insulating layer I3. The protecting layer 510 is located on the fourth insulating layer I4 and covers the photosensitive devices 120. The upper polarizer 210 is located on the protecting layer 510. In this embodiment, the black matrix BM is located on the protecting layer 510, and the upper polarizer 210 is located on the black matrix BM and the protecting layer 510.

In this embodiment, three photosensitive elements L respectively overlap the first sub-pixel SP1, the second sub-pixel SP2, and the third sub-pixel SP3, but the disclosure is not limited thereto. In other embodiments, one photosensitive element L overlaps the first sub-pixel SP1 and the second sub-pixel SP2, and another photosensitive element L overlaps the third sub-pixel SP3. In other embodiments, one photosensitive element L overlaps the first sub-pixel SP1, the second sub-pixel SP2, and the third sub-pixel SP3.

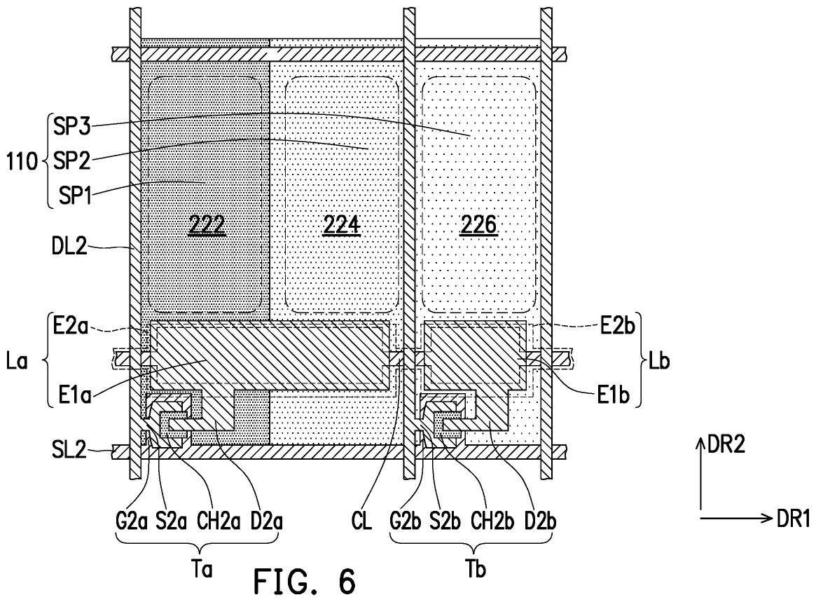

FIG. 6 is a schematic top view of a pixel and photosensitive devices according to an embodiment of the disclosure. It should be noted that the reference numerals and part of the content of the embodiment of FIG. 5A and FIG. 5B are also used to describe the embodiment of FIG. 6, in which identical or similar reference numerals are used to represent identical or similar elements, and descriptions of the same technical content are omitted. Please refer to the descriptions of the previous embodiments for the omitted part, which will not be repeated hereinafter.

The difference between the embodiment of FIG. 6 and the embodiment of FIG. 5A is that in a display device of FIG. 6, a first photosensitive device 120a overlap the first color filter element 222 and the second color filter element 224, and a second photosensitive device 120b overlaps the third color filter element 226. For convenience of description, in FIG. 6, the black matrix, the switch element A of the sub-pixel, the pixel electrode PE, the scan line SL1, and the data line DL1 are omitted.

In this embodiment, the display device includes a first substrate, a pixel 110, the first photosensitive device 120a, the second photosensitive device 120b, and a second substrate. The pixel 110 is located on the first substrate and includes the first sub-pixel SP1, the second sub-pixel SP2, and the third sub-pixel SP3. Each of the first sub-pixel SP1, the second sub-pixel SP2, and the third sub-pixel SP3 includes a switch element and a pixel electrode electrically connected to the switch element, and the first sub-pixel SP1, the second sub-pixel SP2, and the third sub-pixel SP3 respectively includes the first color filter element 222, the second color filter element 224, and the third color filter element 226. An active element is located on a first side of the first substrate.

The first photosensitive device 120a overlaps the first sub-pixel SP1 and the second sub-pixel SP2. The second photosensitive device 120b overlaps the third sub-pixel SP3. The second substrate overlaps the first substrate.

In this embodiment, the first photosensitive device 120a includes an active element Ta and a photosensitive element La.

The active element Ta includes a gate G2a, a channel CH2a, a source S2a, and a drain D2a. The gate G2a is electrically connected to a scan line SL2a. The channel CH2a is located above the gate G2a, and a gate insulating layer is sandwiched between the channel CH2a and the gate G2a. The source S2a and the drain D2a are located above the channel CH2a, and the source S2a is electrically connected to the data line DL2. In some embodiments, ohmic contact layers are provided between the source S2a and the channel CH2a and between the drain D2a and the channel CH2a, but the disclosure is not limited thereto.

The photosensitive element La is located above the gate insulating layer and overlaps the common signal line CL. The photosensitive element La includes a first electrode E1a, a second electrode E2a, and a photosensitive layer (not shown). The first electrode E1a is electrically connected to the active element Ta and the drain D2a.

In this embodiment, the second photosensitive device 120b includes an active element Tb and a photosensitive element Lb.

The active element Tb includes a gate G2b, a channel CH2b, a source S2b, and a drain D2b. The gate G2b is electrically connected to a scan line SL2b. The channel CH2b is located above the gate G2b, and a gate insulating layer is sandwiched between the channel CH2b and the gate G2b. The source S2b and the drain D2b are located above the channel CH2b, and the source S2b is electrically connected to the data line DL2. In some embodiments, ohmic contact layers are provided between the source S2b and the channel CH2b and between the drain D2b and the channel CH2b, but the disclosure is not limited thereto. A bottom-gate type thin film transistor is treated as an example to act as each of the active element Ta and the active element Tb for description, but the disclosure is not limited thereto. According to other embodiments, each of the active element Ta and the active element Tb may also be a top-gate type thin film transistor.

The photosensitive element Lb is located above the gate insulating layer and overlaps the common signal line CL. The photosensitive element Lb includes a first electrode E1b, a second electrode E2b, and a photosensitive layer (not shown). The first electrode E1b is electrically connected to the active element Tb and the drain D2b. The second electrode E2a and the second electrode E2b are connected to each other and extend in the first direction DR1.

An area of the second photosensitive device Lb is different from an area of the first photosensitive device La. In this embodiment, the area of the photosensitive element La is greater than the area of the photosensitive element Lb. In this embodiment, an area of a photosensitive layer of the photosensitive element La is greater than an area of a photosensitive layer of the photosensitive element Lb. In some embodiments, the area of the photosensitive layer of the photosensitive element La is approximately equal to an overlapping area of the first electrode E1a and the second electrode E2a, and the area of the photosensitive layer of the photosensitive element Lb is approximately equal to an overlapping area of the first electrode E1b and the second electrode E2b.

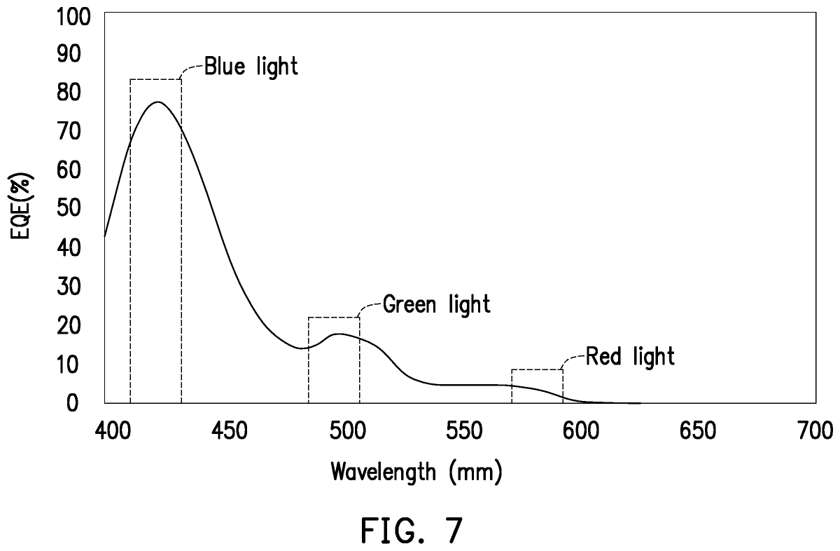

FIG. 7 is a schematic graph of a relationship between external quantum efficiency (EQE, %) of the photosensitive device and a wavelength according to some embodiments of the disclosure. In some embodiments, the photosensitive element has poor sensitivity to red light and green light, so a larger light-receiving area is required for red light and green light to sense more light.

In some embodiment of FIG. 6, the first color filter element 222, the second color filter element 224, and the third color filter element 226 respectively are a red filter element, a green filter element, and a blue filter element. In other words, in this embodiment, the red sub-pixel and the green sub-pixel share one first photosensitive device 120a, and the blue sub-pixel uses the second photosensitive device 120b alone.

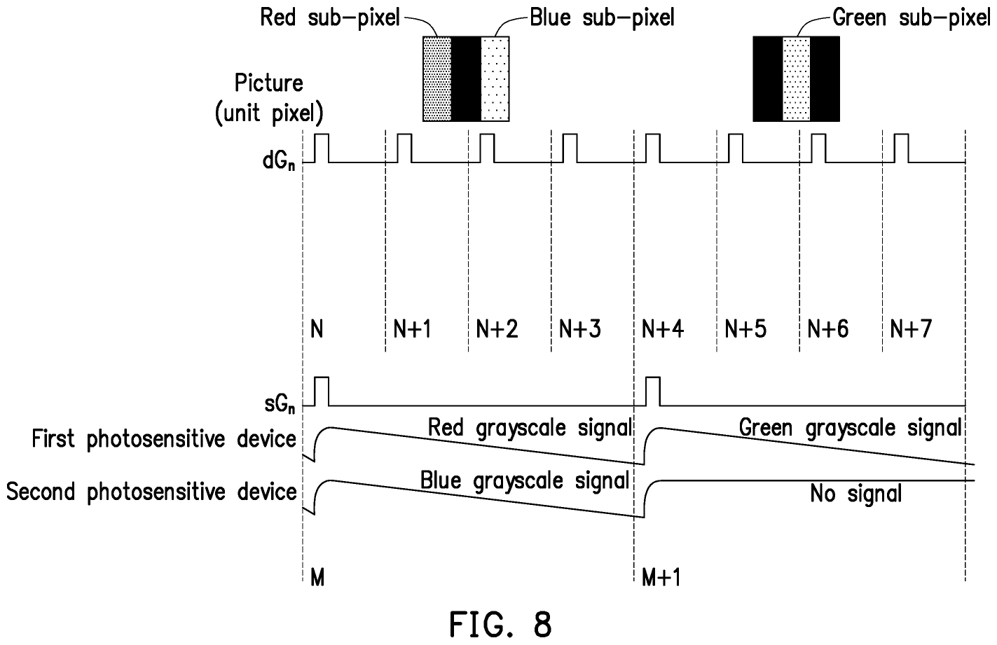

FIG. 8 is a timing diagram of signals during scanning performed by a display device according to an embodiment of the disclosure.

With reference to FIG. 6 and FIG. 8, dGn represents the signal on the scan line of the first sub-pixel SP1, the second sub-pixel SP2, and the third sub-pixel SP3 in the display device. In the N^{th} to N+3^{th} frame of dGn, the first sub-pixel SP1 and the third sub-pixel SP3 are turned on, and the second sub-pixel SP2 is turned off. At this time, the scanning region of the display device emits the first color light and the third color light (red light and blue light).

sGn represents the signal on the scan line of the first photosensitive device 120a and the second photosensitive device 120b in the display device. In the M^{th} frame of sGn, the first color light reflects off the object and is then received by the first photosensitive device 120a and converted into a red grayscale signal. The third color light reflects off the object and is then received by the second photosensitive device 120b and converted into a blue grayscale signal.

In the N+4^{th} to N+7^{th} frame of dGn, the second sub-pixel SP2 is turned on and the first sub-pixel SP1 and the third sub-pixel SP3 are turned off. At this time, the scanning region of the display device emits the second color light (green light).

In the M+1^{th} frame of sGn, the second color light reflects off the object and is then received by the first photosensitive device 120a and converted into a green grayscale signal. The third color light reflects off the object, and no signal is received by the second photosensitive device 120b.

The red grayscale signal, the green grayscale signal, and the blue grayscale signal are calculated (e.g., multiplied by the first constant, the second constant, and the third constant, respectively) to respectively obtain red data, green data, and blue data. Finally, the red data, green data, and blue color data are combined to obtain an image of the object.

In view of the foregoing, in the disclosure, the display function and the color scanning function are integrated in the same device, and the functions of object scanning and picture displaying are provided on the same surface of the display panel together. In addition, in the disclosure, the grayscale signal is converted into color data by calculation, and different color data are combined to obtain a color image.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A display device, comprising:
a first substrate;
a red sub-pixel, a green sub-pixel, and a blue sub-pixel, located on a first side of the first substrate, wherein each of the red sub-pixel, the green sub-pixel, and the blue sub-pixel comprises a switch element and a pixel electrode electrically connected to the switch element;
a plurality of photosensitive devices, located on the first side of the first substrate, wherein each of the photosensitive devices overlaps at least one of the red sub-pixel, the green sub-pixel, and the blue sub-pixel, and each of the photosensitive devices comprises:
an active element, located on the first substrate; and
a photosensitive element, electrically connected to the active element; and
a second substrate, overlapping the first substrate.

2. The display device according to claim 1, further comprising:
a collimator structure, overlapping the pixels and the photosensitive devices.

3. The display device according to claim 1, wherein a gate of the switch element and a gate of the active element belong to a same conductive layer.

4. The display device according to claim 1, wherein:
the red sub-pixel, the green sub-pixel, and the blue sub-pixel respectively comprise a red filter element, a green filter element, and a blue filter element.

5. The display device according to claim 4, wherein at least three of the photosensitive elements individually overlap the red filter element, the green filter element, and the blue filter element.

6. The display device according to claim 1, wherein the switch element and the active element are located between the first substrate and the second substrate.

7. A display device, comprising:
a first substrate;
a pixel, located on the first substrate, wherein the pixel comprises a first sub-pixel, a second sub-pixel, and a third sub-pixel;
a first photosensitive device, overlapping the first sub-pixel and the second sub-pixel;
a second photosensitive device, overlapping the third sub-pixel, wherein an area of the second photosensitive device is different from an area of the first photosensitive device; and
a second substrate, overlapping the first substrate.

8. The display device according to claim 7, wherein the first sub-pixel, the second sub-pixel, and the third sub-pixel respectively comprises a red filter element, a green filter element, and a blue filter element.

9. The display device according to claim 7, wherein the first photosensitive device comprises a first active element and a first photosensitive element electrically connected to the first active element, and the second photosensitive device comprises a second active element and a second photosensitive element electrically connected to the second active element, wherein an area of the first photosensitive element is greater than an area of the second photosensitive element.

10. A method of image scanning, comprising:
providing a display device, wherein the display device comprises:
a first substrate;
a pixel, located on the first substrate, wherein the pixel comprises a first sub-pixel, a second sub-pixel, and a third sub-pixel;
a plurality of photosensitive devices, overlapping the first sub-pixel, the second sub-pixel, and the third sub-pixel; and
a second substrate, overlapping the first substrate;
placing an object on the display device;
turning on the first sub-pixel, wherein the display device emits first color light, and the first color light is received by at least one of the photosensitive devices and converted into a first grayscale signal after reflecting off the object;
turning on the second sub-pixel, wherein the display device emits second color light, and the second color light is received by at least one of the photosensitive devices and converted into a second grayscale signal after reflecting off the object;
turning on the third sub-pixel, wherein the display device emits third color light, and the third color light is received by at least one of the photosensitive devices and converted into a third grayscale signal after reflecting off the object;
multiplying the first grayscale signal by a first constant to obtain first color data;
multiplying the second grayscale signal by a second constant to obtain second color data;
multiplying the third grayscale signal by a third constant to obtain third color data; and
combining the first color data, the second color data, and the third color data to obtain an image of the object.

11. The method of image scanning according to claim 10, wherein the first sub-pixel, the second sub-pixel, and the third sub-pixel are turned on at a same time.

12. The method of image scanning according to claim 10, wherein the first sub-pixel and the third sub-pixel are turned on at a same time, and the second sub-pixel is not turned on when the first sub-pixel and the third sub-pixel are turned on.
